(19) United States
(12) Patent Application Publication
(10) Pub. No.: US 2004/0088707 A1
(43) Pub. Date: May 6, 2004

(54) Operating mode for a computer

(75) Inventor: Reiner Muller, Pinzberg (DE)

Correspondence Address: Henry M. Feiereisen, Suite 4714, 350 Fifth Avenue, New York, NY, 10118, US

(73) Assignee: SIEMENS AKTIENGESELLSCHAFT, Munchen (DE)

(21) Appl. No.: 10/653,716

(22) Filed: Aug. 29, 2003

(30) Foreign Application Priority Data
Aug. 29, 2002 (DE) 102 39 805.4

(51) Int. Cl. G06F 9/00

(52) U.S. Cl. 718/106

(57) ABSTRACT

A central processor of the computer executes a basic operating system and at least one additional operating system, such as an auxiliary operating system, that is executed substantially in parallel with the basic operating system. When executing the basic operating system, the central processor checks if a resource can be operated by the auxiliary operating system. If the check is affirmative, then the central processor operates the resource from the auxiliary operating system; however, if the check is negative, then the resource is operated by the basic operating system or by another additional operating system.

### CROSS-REFERENCES TO RELATED APPLICATIONS

This application claims the priority of German Patent Application, Serial No. 102 39 805.4, filed Aug. 29, 2002, pursuant to 35 U.S.C. 119(a)-(d), the disclosure of which is incorporated herein by reference.

### BACKGROUND OF THE INVENTION

The present invention relates to an operating mode for a computer with a central processing unit that executes a basic operating system and at least one additional system, as well as to a computer program product and a computer apparatus employing the operating mode.

In control systems that operate under computer control, the same central processor frequently executes several operating systems. One of the operating systems, subsequently referred to as basic operating system, is typically a real-time operating systems used to control processes in real time. An additional operating system, subsequently referred to as auxiliary operating system, is typically a so-called mainstream operating system that does not operate in real time. Its mission is to support communication with other computers as well as with components associated with the central processor. The components include typically input, output and bidirectional resources. An example of an input resource is a keyboard, a mouse or a joystick. An output resource is, for example, the monitor or a printer. Bidirectional resources are, for example, a communication interface or an interface to a hard disk.

If the auxiliary operating system fails in conventional systems, the resources operated by the obsolete operating system are no longer available to the basic operating system which is still running. These resources, however, can be important also for the operation of the basic operating system. In conventional systems, the failure of the auxiliary operating system can limit the operation of the basic operating system, or the operation of the basic operating system may have to be restricted for safety reasons. Sometimes, the control the system has to be placed in a safe state or has to be shut down completely.

It would therefore be desirable and advantageous to provide an improved operating mode for a computer, which obviates prior art shortcomings and enables specifically the continued operation of the basic operating system.

### SUMMARY OF THE INVENTION

The invention relates to an operational process of a computer having a central processor executing a basic operating system and at least one additional operating system. The invention also relates to a computer program for carrying out the process and to a computer apparatus implementing the computer program.

According to one aspect of the invention, an operating mode for a computer with a central processor executes a basic operating system and at least one additional operating system substantially in parallel with the basic operating system. The central processor checks while executing the basic operating system, if a resource can be operated by a first of the at least one additional operating system. If the resource can be operated by the first additional operating system, then the central processor operates the resource from the additional operating system. Otherwise, the central processor operates the resource from the basic operating system or from another of the at least one additional operating system that is different from the first additional operating system.

According to another aspect of the invention, a computer program residing on a computer readable medium includes instructions for causing a computer to execute a basic operating system and at least one additional operating system substantially in parallel with the basic operating system. The central processor then check, as described above, while executing the basic operating system, if a resource can be operated by a first of the at least one additional operating system. If the resource can be operated by the first additional operating system, then the central processor operates the resource from the additional operating system. Otherwise, the central processor operates the resource from the basic operating system or from another of the at least one additional operating system that is different from the first additional operating system.

According to yet another aspect of the invention, a computer apparatus is provided that includes the program instructions of the afore-described computer program.

The basic operating system is therefore not weighed down with non-system-related tasks during normal operation. The respective resource can still be operated even when the auxiliary operating system fails.

According to one feature of the invention, the basic operating system is a real-time operating system. The auxiliary operating system or the optional additional operating system, on the other hand, does not operate in real time.

The resource may be an input resource. Examples for input resources are a keyboard, a mouse or a joystick, or for example a warning from a uninterruptible power supply (UPS) indicating that a power level can no longer be maintained or can be maintained only for a limited time.

The resource can also be an output resource. According to one feature of the invention, the basic operating system can display a message on the monitor of the computer indicating a failure of the auxiliary operating system. The monitor can also display messages regarding the states of a regulated system.

The resource can also be a bidirectional resource. For example, a communication can be established via a communication interface with other computers, or data can be written to or read from the hard disk of the computer.

It can be tested for a specific resource if the auxiliary operating system resource can operate resource-specific, which represents a particularly efficiently operating mode. The resources of the basic operating system are only used when the specified resource is to be operated and the auxiliary operating system is unable to operate the specified resource.

Conversely, the test for determining if the auxiliary operating system resource is able to operate the particular resource may encompass testing more than a single resource at one time. This operating mode is also quite efficient because not so that many individual tests for each individual resource are required. This applies in particular to the tests relating to the auxiliary operating system.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a block circuit diagram of a computer, and

FIG. 2 shows a process flow.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

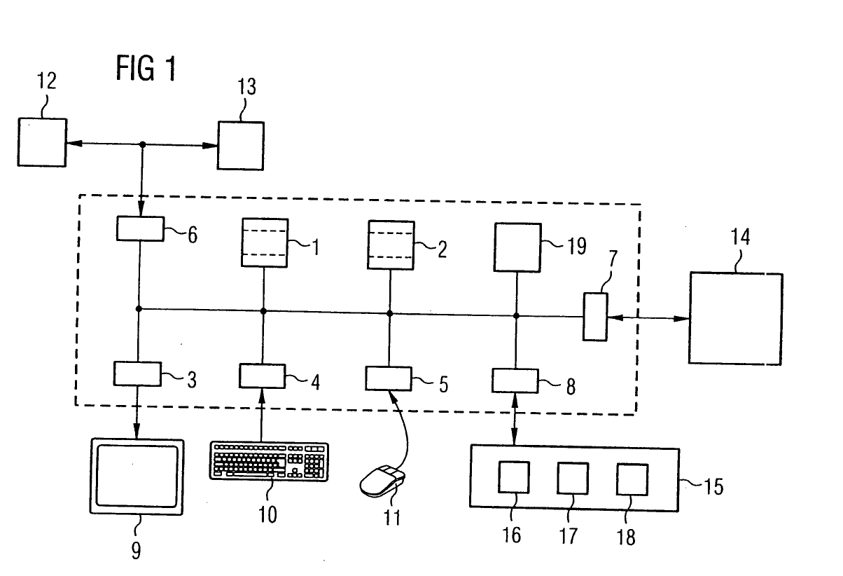

Turning now to the drawing, and in particular to FIG. 1, there is shown a computer which includes a—preferably non-redundant—central processor 1, a working memory 2 and a plurality of interfaces 3 to 8. The central processor 1 can operate, for example via the interface 3, an output resource 9, such as the exemplary monitor 9. The central processor 1 can operate via the interfaces 4 and 5 input resources 10 and 11, in the present example a keyboard 10 and a mouse 11. Instead of the mouse 11, a joystick can also be operated. The interface 6 allows communication with external components 12 and 13. The external components 12 and 13 can be, for example, a master control unit 12 and a slave control unit 13. The components 12 and 13 represent bidirectional resources 12 and 13. Via the interface 7, a device 14, such as a machine-tool 14, can be controlled. Via the interface 8, a hard disk 15 may be controlled. The controlled device 14 and the hard disk 15 are also bidirectional resources 14, 15.

Several operating systems 16 to 18 are stored on the hard disk 15. These are a basic operating system 16, an auxiliary operating system 17, as well as perhaps an additional operating system 18 which is optional. The purpose for assigning different names to the operating systems 16 to 18 is merely to differentiate between the operating systems 16 to 18.

The operating systems 16 to 18 functionally complement each other. They are loaded by the central processor 1 into the working memory 2 and are executed substantially in parallel. In other words, the operating systems 16 to 18 “share” the central processor 1 and the working memory 2. This is indicated in FIG. 1 by the dotted lines.

The basic operating systems 16 is a real-time operating system, for example a so-called NRK (NRK=Numeric Robotic Kernel) for a SINUMERIK controlled supplied by Siemens AG, Germany. The operating system 16 is used to control the machine-tool 14. The basic operating system 16 is implemented as a computer program product 16 used to program the computer. The auxiliary operating system 17 and the additional operating system 18 are operating systems 17, 18 that do not operate in real time. The auxiliary operating system 17 can be, for example, Windows NT, the additional operating system 18 can be a UNIX® system. The operating system 17, 18 that do not operate in real time—in particular the auxiliary operating system 17—serve therefore in particular the interfaces 3 to 5 used to communicate with a user.

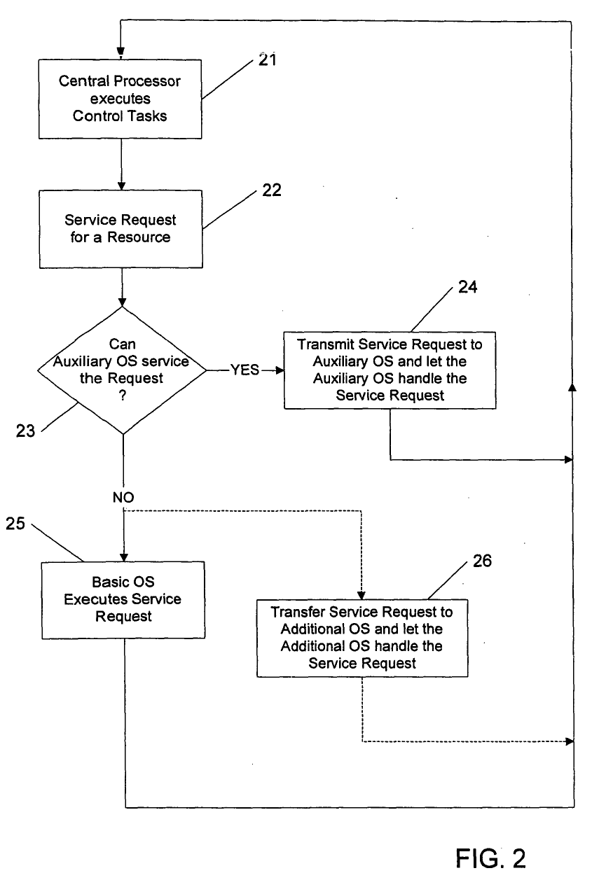

During execution of the basic operating system 16, the computer runs in an operating mode, which will be described hereinafter in more detail with reference to FIG. 2. The entire sequence of steps described with reference to FIG. 2 is hereby executed within the context of the execution of the basic operating system 16.

According to FIG. 2, in a first step 21, the central processor 1 executes control tasks. In step 21, the central processor accesses in particular the controlled device 14 via the interface 7. In a normal operating mode of the computer, the interface 7 is therefore already operated by the basic operating system 17.

In step 22, operate to one of the resources 9 to 13 or 15 is requested. The operational request can therefore selectively target an input resource 10, 11, an output resource 9, or a bidirectional resource 12, 13, 15.

In step 23, the central processor 1 checks if the corresponding resource 9 to 13 or 15 can be operated by the auxiliary operating system 17. This can be checked, for example, by checking if the auxiliary operating system 17 is in a failure routine. The address of failure routines are known in particular for Windows NT. Accordingly, a failure of the auxiliary operating system 17 can be recognized and transmitted to the basic operating system 16. Other monitoring modes are possible. For example, the computer can include a watchdog routine 19, which is reset by the auxiliary operating system 17 in regular intervals. Execution of the watchdog routine 19 would indicate a failure of the auxiliary operating system 17.

If it is determined in step 23 that the auxiliary operating system 17 is executed normally, then the resource 9 to 13 or 15 can be operated by the auxiliary operating system 17. In this case, in a step 24 the service requests is transmitted to and executed by the auxiliary operating system 17.

Conversely, if it is determined in step 23 that the auxiliary operating system 17 cannot operate the resource 9 to 13 or 15, then the resource 9 to 13 or 15 is operated by the basic operating system 16 itself, as shown in step 25. If in the present example the additional operating system 18 can operate the resource 9 to 13 or 15, then the service request can also be transmitted to and executed by the additional operating system 18 in a step 26. This is indicated in FIG. 2 by the dotted line.

In the operating mode described above with reference to FIG. 2, the test that indicates if the resource 9 to 13 or 15 can be operated by the auxiliary operating system 17 is performed across the resources, and can be specific for the operating system. It is also possible to modify the process so that the test is resource-specific, i.e., the test is performed separately for each resource 9 to 13 or 15. More particularly, for each service request, the auxiliary operating system 17 can be requested to initially operate the corresponding resource 9 to 13 or 15, with the basic operating system 16 waiting for a certain wait time. If the auxiliary operating system 17 executes the service requests, then it is obviously able to operate the resource 9 to 13 or 15. Conversely, if the wait time expires and the resource 9 to 13 or 15 have not been operated by the auxiliary operating system 17, then the basic operating system 16 interprets this event as an inability of the auxiliary operating system 17 to operate the resource 9 to 13 or 15. In this case, after the wait period has expired, the basic operating systems issues the service request itself and/or transmits the service request to the additional operating system 18.

With the operating mode according to the invention, the basic operating system 16 can readily continue to operate, even if the auxiliary operating system 17—and not the central processor 1 itself—has failed entirely or partially. This can also reduce the wiring costs. For example, an input resource of an uninterruptible power supply (UPS) needs no longer be accessible to both the basic operating system 16 and the auxiliary operating system 17. It is then sufficient if under normal conditions the auxiliary operating system 17 queries the input resource only in the event of a failure of the auxiliary operating system 17. A query by the additional operating system 18 and/or the basic operating system 16 occurs only if the auxiliary operating system 17 fails.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An operating mode for a computer having a central processor executing a basic operating system and at least one additional operating system which is executed by the central processor substantially in parallel with the basic operating system, wherein the central processor checks while executing the basic operating system, if a resource can be operated by a first of the at least one additional operating system, and wherein
if the resource can be operated by the first additional operating system, then the central processor operates the resource from the additional operating system, and
if the resource cannot be operated by the first additional operating system, then the central processor operates the resource from the basic operating system or from another of the at least one additional operating system that is different from the first additional operating system.

2. The operating mode of claim 1, wherein the basic operating system is a real-time operating system.

3. The operating mode of claim 1, wherein the first additional operating system is an operating system that does not execute in real time.

4. The operating mode of claim 1, wherein the other additional operating systems does not execute in real time.

5. The operating mode of claim 1, wherein the resource is an input resource.

6. The operating mode of claim 1, wherein the resource is an output resource.

7. The operating mode of claim 1, wherein the resource is a bidirectional resource.

8. The operating mode of claim 1, wherein the check if the resource can be operated by the first additional operating system is resource-specific.

9. The operating mode of claim 1, wherein the check if the resource can be operated via the first additional operating system includes several resources.

10. The operating mode of claim 9, wherein the check if the resource can be operated by the first additional operating system is specific for the first additional operating system.

11. A computer program, residing on a computer readable medium, comprising instructions for causing a computer to:
execute a basic operating system and at least one additional operating system substantially in parallel with the basic operating system;
the central processor to check while executing the basic operating system, if a resource can be operated by a first of the at least one additional operating system; and
if the resource can be operated by the first additional operating system, the central processor to operate the resource from the additional operating system, and
if the resource cannot be operated by the first additional operating system, the central processor to operate the resource from the basic operating system or from another of the at least one additional operating system that is different from the first additional operating system.

12. Apparatus comprising a computer readable storage medium tangibly embodying program instructions for interfacing a programmable processor with a plurality of resources, the program instructions including instructions operable for causing the processor to:
execute a basic operating system and at least one additional operating system substantially in parallel with the basic operating system;
check while executing the basic operating system, if a resource can be operated by a first of the at least one additional operating system; and
if the resource can be operated by the first additional operating system, the programmable processor to operate the resource from the additional operating system, and
if the resource cannot be operated by the first additional operating system, the programmable processor to operate the resource from the basic operating system or from another of the at least one additional operating system that is different from the first additional operating system.
